(19) United States
(12) Patent Application Publication
(10) Pub. No.: US 2005/0263104 A1
(43) Pub. Date: Dec. 1, 2005

(54) Canine uniform

(75) Inventor: Linda M. Lazarowich, Winnipeg (CA)

Correspondence Address: AIKINS PATENT COMPANY, 30TH FLOOR, 360 MAIN STREET, WINNIPEG, MB, R3C 4G1, CA

(73) Assignee: K9 PRO WEAR, WINNIPEG (CA)

(21) Appl. No.: 10/846,667

(22) Filed: May 17, 2004

(51) Int. Cl. A01K 13/00

(52) U.S. Cl. 119/850

(57) ABSTRACT

A uniform is worn by a working canine to identify a task or organization with which the canine is associated. The uniform includes a vest with a back portion across the animal's back, belly panels extending from opposite sides of the back portion to wrap around the animal's torso and connected by appropriate fasteners Neck panels wrap around the animal's neck and are connected by suitable fasteners. Visual indicia are affixed to the uniform displaying the task or organization with which the animal is associated. The animal is thus readily identified to the public and to security personnel as a working animal, not a stray or feral dog. The result is reduced or no interference with the animal as it performs its duties.

### FIELD OF THE INVENTION

The present invention relates to accessories for working animals and more particularly to uniforms for identifying working dogs.

### BACKGROUND

Working animals, particularly dogs trained for police, security and similar tasks, are often mistaken for stray animals, possibly escaped pets This can lead to persons approaching and attempting to pet or capture an animal, interfering with the performance of a task to which it has been assigned. Dogs working in security may be taken for feral strays posing a danger, especially when apprehending an individual suspected of criminal activity. Such animals are in danger of being shot and killed by police or other security personnel unfamiliar with the animal in question.

The present invention aims at the amelioration of these problems.

### SUMMARY

According to the present invention there is provided a uniform to be worn by a working canine to identify a task or organization with which the canine is associated, the uniform comprising:
a vest with a back portion to extend across the animal's back, belly panels extending from opposite sides of the back portion to wrap around the animal's torso, fasteners for connecting the belly panels, neck panels extending from the back potion to wrap around the animal's neck and neck fasteners for connecting the neck panels; and
visual indicia affixed to the uniform displaying said task or organization.

The animal is thus readily identified as a working animal, not a stray, and one that may benefit from the assistance of security officers in such tasks as apprehending individuals involved in criminal activities, for example in an instance of riot, insurrection, riot or looting.

The uniform may incorporate puncture resistant materials, especially puncture resistant textile fabrics. This provides physical protection against accidental or, in some cases, intentional, injury. The protective materials maybe of a standard considered “bullet-proof”, but this would normally make the uniform so heavy as to interfere with mobility and endurance. Instead, sheets of puncture resistant textile fabric may be incorporated as a light weight interlining or inserted in pockets in the uniform when desired. The general design is well suited to be worn over the available canine bullet-proof vests where this degree of protection is required.

Typical indicia applied to the uniform will include the words “Police”, “Security”, “Rescue” and “Narcotics”. Appropriate recognizable emblems and acronyms (e.g. FBI; DEA; RCMP) may also be used.

The uniform is desirably made in a colour that is commonly used for the human uniforms of the organization in question, for example a dark blue for police forces. Reflective and daylight fluorescent materials may be used for high visibility.

### BRIEF DESCRIPTION OF THE DRAWINGS

In the accompanying drawings, which illustrate an exemplary embodiment of the present invention:

FIG. 1 is a side view of a dog wearing a uniform according to the present invention;

FIG. 2 is a plan view showing the outside of the uniform, stretched out flat; and

FIG. 3 is a plan view of another embodiment of the invention.

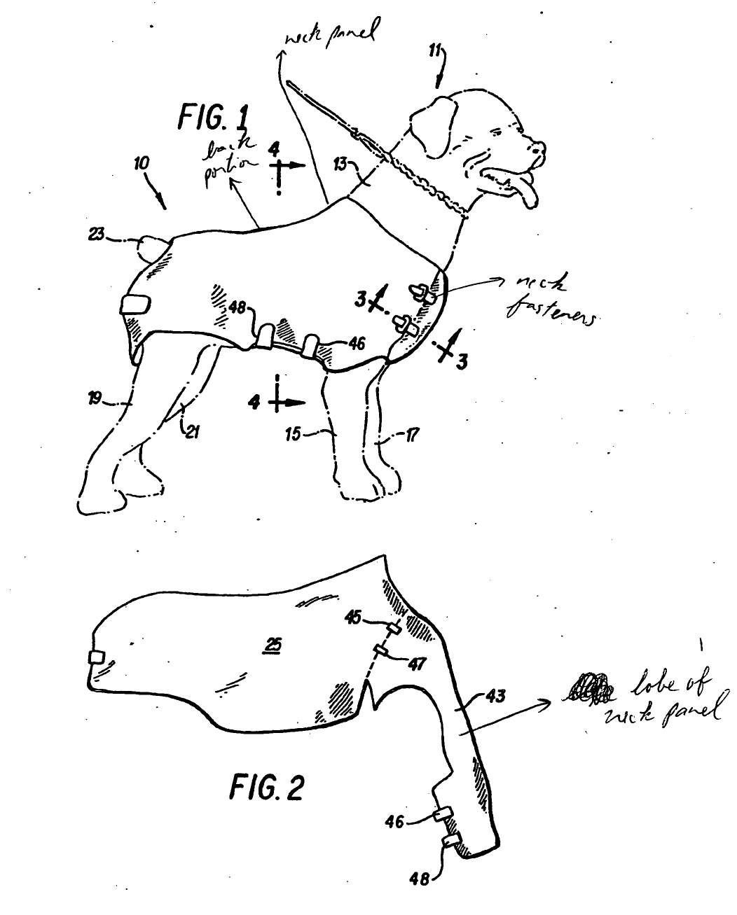

### DETAILED DESCRIPTION

Referring to the accompanying drawings, and particularly FIG. 1, there is illustrated a dog 10 engaged in police work, wearing a canine uniform 12 according to the present invention. The uniform is made with a textile fabric shell 14 in police colours. It has a main panel or back portion 16 that extends over the back of the dog from the neck to near the tail. Two lobes 18 extend from opposite sides of the main panel and wrap round the animal, under the torso these lobes are equipped with interengaging fasteners 20 and 22, for example a hook and loop fastener of the type sold under the trade mark “Velcro”. When connected, these lobes serve as belly panels securing the uniform in place. Additional lobes 24 project from the neck end of the main panel to wrap around the animal's neck as neck panels. They are connected by interengaging fastener components 26 and 28 to complete the placement of the uniform on the dog.

To ensure that the animal's function will be recognized immediately by members of the public, enforcement officers and any others in the vicinity, the uniform bears indicia 30 and 32 that cannot be mistaken. In this case, the indicia include the designation “POLICE” and the emblem or shield of the force in question.

As a protective measure, the uniform may include an interlining 34 of puncture resistant textile fabric between the shell 14 and a fabric lining (not illustrated). Alternatively, pockets 36 may be provided on the inside of the shell to accommodate sheets of protective material.

To ensure high visibility and instant recognition even under low light conditions, as at night, the uniform has bands 38 and 40 of reflective material.

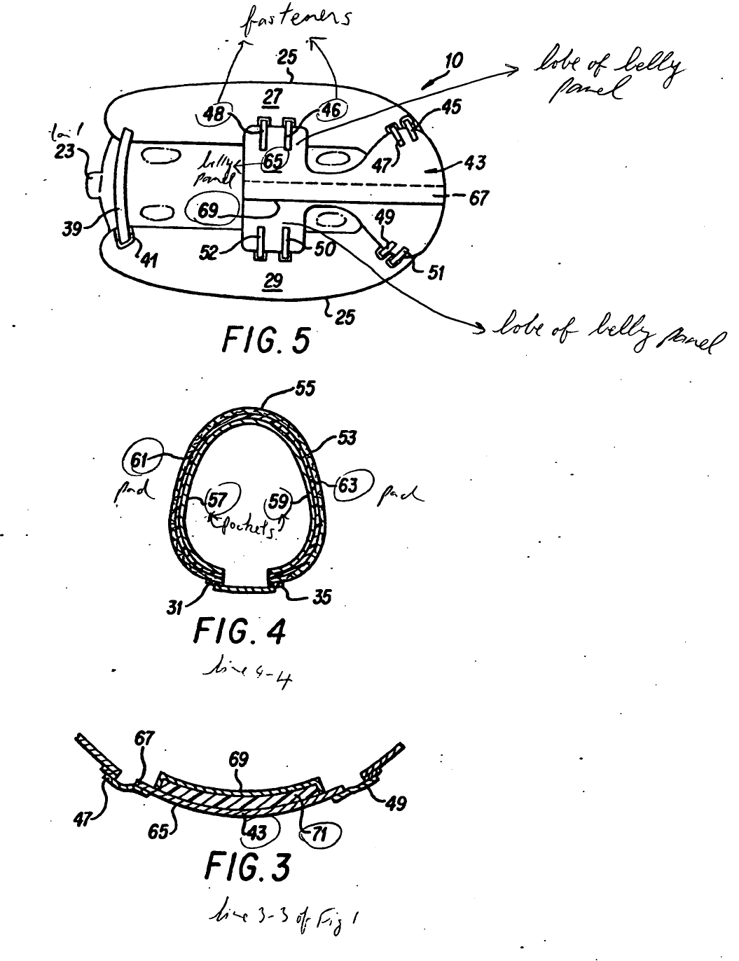

An alternative embodiment of the uniform is illustrated in FIG. 3, the uniform 42 is intended to be worn by a canine trained for rescue work. The indicia 44 include the word “RESCUE”. The uniform colour is a bright “day glow” pigment for high visibility under all conditions, including from the air. The uniform has a pocket 46 for a radio or GPS set and may include others (not illustrated) for other items, for example a first aid kit. Another pocket 48 is a chest pocket for carrying identification documents.

While particular embodiments of the present invention have been described in the foregoing, it is to be understood that other embodiments are possible within the scope of the invention. Thus, for example, the uniform may be made with mesh panels or pockets for retaining cold packs for use in hot weather. For cold conditions, the shell may be lined with an insulating material. Other options include an opening on the back for access to a tracking harness worn under the uniform; an extraction handle for lifting the dog; an integrated tracking harness; and accessory loops for attaching accessory garments and the like to the uniform. The invention is thus to be considered limited solely by the scope of the appended claims.

1. A uniform to be worn by a working canine to identify a task or organization with which the canine is associated, the uniform comprising:
a vest with a back portion to extend across the animal's back, belly panels extending from opposite sides of the back portion to wrap around the animal's torso, fasteners for connecting the belly panels, neck panels extending from the back portion to wrap around the animal's neck and neck fasteners for connecting the neck panels;
the back portion and the belly panels comprising a lightweight lining consisting of puncture resistant material; and
visual indicia affixed to the uniform displaying said task or organization.

2. (canceled)

3. (canceled)

4. (canceled)

5. (canceled)

6. A uniform according to claim 1 wherein the puncture resistant material comprises sheets of puncture resistant textile fabric.

7. A uniform according to claim 1 comprising external surface areas that exhibit daylight fluorescence.

8. A uniform according to claim 1 comprising reflective external surface areas.

9. A uniform according to claim 1 wherein the indicia are selected from the group consisting of the words “Police”. “Security” and “Rescue”.

10. (canceled)

11. A uniform according to claim 1 wherein the fasteners comprise interengaging hook and loop fasteners.

12. A uniform to be worn by a working canine to identify a task or organization with which the canine is associated the uniform comprising:
a vest consisting of a back portion to extend across the animal's back, belly panels extending from opposite sides of the back portion to wrap around the animal's torso, fasteners for connecting the belly panels, neck panels extending from the back portion to wrap around the animal's neck and neck fasteners for connecting the neck panels;
the vest being formed of material comprising a mesh material;
visual indicia affixed to the uniform displaying said task or organization:
and cold packs inserted into pockets on the vest.

13. A uniform according to claim 12 wherein at least the back portion and belly panels comprise a protective material.

14. A uniform according to claim 13 wherein the protective material is incorporated as an interlining into the back portion and belly panels.

15. A uniform according to claim 13 wherein the protective material comprises sheets of material inserted into pockets in the uniform.

16. A uniform according to claim 13 wherein the puncture resistant material comprises sheets of puncture resistant textile fabric.

17. A uniform according to claim 12 comprising external surface areas that exhibit daylight fluorescence.

18. A uniform according to claim 12 comprising reflective external surface areas.

19. (canceled)

20. (canceled)

21. A uniform according to claim 1 in combination with a bullet proof vest in which the uniform is worn over the bullet proof vest and the puncture resistant material is lighter than material of the bullet proof vest

22. A uniform to be worn by a working canine wearing a tracking harness, to identify a task or organization with which the canine is associated, the uniform comprising:
a vest consisting of a back portion to extend across the animal's back, belly panels extending from opposite sides of the back portion to wrap around the animal's torso, fasteners for connecting the belly panels, neck panels extending from the back portion to wrap around the anirnal's neck and neck fasteners for connecting the neck panels;
the vest being formed of material comprising a mesh material;
reflective external surface areas on the vest;
visual indicia affixed to the uniform displaying said task or organization;
an opening in the back portion arranged for access to the tracking harness;
cold packs inserted into pockets on the vest; and
a chest pocket for locating identification documents therein.

23. A uniform to be worn by a working canine wearing a tracking harness, to identify a task or organization with which the canine is associated, the uniform comprising:
a vest with a back portion to extend across the animal's back, belly panels extending from opposite sides of the back portion to wrap around the animal's torso, fasteners for connecting the belly panels, neck panels extending from the back portion to wrap around the animal's neck and neck fasteners for connecting the neck panels;
the back portion and the belly panels comprising a lightweight lining of puncture resistant material;
reflective external surface areas on the vest;
a lining on the vest of insulating material;
a chest pocket for locating identification documents therein;
an opening in the back portion arranged for access to the tracking harness;
visual indicia affixed to the uniform displaying said task or organization.

24. A uniform according to claim 23 in combination with a bullet proof vest in which the uniform is worn over the bullet proof vest and the puncture resistant material is lighter than material of the bullet proof vest.

25. A method of identifying a task or organization with which a working canine is associated, the working canine having a tracking harness, the method comprising:
providing a vest with a back portion with an opening, belly panels extending from opposite sides of the back portion, and neck panels extending from the back portion;
extending the back portion across the animal's back;
wrapping the belly panels around the animal's torso and connecting the belly panels with fasteners;
wrapping the neck panels around the animal's neck and connecting the neck panels with fasteners;
providing a lining on the back portion and the belly panels consisting of lightweight puncture resistant material;
providing reflective external surface areas on the vest;
locating identification documents in a chest pocket on the uniform;
supporting cold packs on the vest; and
displaying said task or organization with which the working canine is associated by affixing visual indicia to the uniform.

26. The method according to claim 25 including providing a bullet proof vest and placing the uniform so as to be worn by the working canine over the bullet proof vest.

27. The method according to claim 25 including providing an opening in the back portion of the vest and accessing the tracking harness through the opening in the back portion.
